(19) United States
(12) Patent Application Publication
(10) Pub. No.: US 2024/0018297 A1
(43) Pub. Date: Jan. 18, 2024

(54) POLYMERIZING COMPOSITION, METHOD OF MANUFACTURE THEREOF AND ARTICLES COMPRISING THE SAME

(71) Applicants: The University of Massachusetts, Boston, MA (US); BASF SE, Ludwigshafen am Rhein (DE)

(72) Inventors: Alan James Lesser, Shutesbury, MA (US); Daniel Scott Camarda, Amherst, MA (US); Matthew Lampe, Amherst, MA (US); Anna Maria Mueller-Cristadoro, Lemfoerde (DE); Mark D. Minnichelli, Budd Lake, NJ (US); Chinmay Mangesh Saraf, Amherst, MA (US); Martin Linnenbrink, Lemfoerde (DE); John Daguerre-Bradford, West Simsbury, CT (US)

(21) Appl. No.: 18/032,818

(22) PCT Filed: Oct. 20, 2021
(86) PCT No.: PCT/US2021/055795

§ 371 Date: Apr. 20, 2023

Related U.S. Application Data
(60) Provisional application No. 63/093,923, filed on Oct. 20, 2020.

(51) Int. Cl. C08G 59/24; C08K 3/36; C08G 59/16; C09J 163/00; C08G 59/68

(52) U.S. Cl. CPC C08G 59/245; C08K 3/36; C08G 59/1455; C09J 163/00; C08G 59/683; C09J 2301/416; C09J 2301/304; C09J 2463/00

(57) ABSTRACT

Disclosed herein is a composition comprising a cationically polymerizable first epoxide and a second epoxide. The first epoxide is a glycidyl epoxide and the second epoxide further comprises a glycidyl epoxide and/or a non-glycidyl epoxide. The disclosed composition further comprises an initiator and a filler, where the composition upon external stimulus undergoes an ionic polymerization reaction in a spatially propagating reaction front or in a global reaction that occurs throughout an entire composition.

### CROSS REFERENCE TO RELATED APPLICATIONS

This application claims the benefit of U.S. Application No. 63/093,923 filed on Oct. 20, 2020, which is incorporated herein by reference in its entirety.

### BACKGROUND

Disclosed herein is a polymerizing composition, methods of manufacture thereof and articles comprising the same.

An adhesive is any substance applied to the surfaces of materials that binds them together and resists separation. An ideal adhesive not only should have a long shelf life but also have a potential to be cured on demand. It is highly desirable for adhesives to be cured employing energy that can be applied externally. Such curing by the application of external energy ensures that the entire assembly need not be placed in a large oven, thermal blanket, or radiant heater. Adhesives cured by such techniques provide tremendous advantage for flexible and efficient manufacturing processes.

For flexible and efficient manufacturing, it is ideal to have adhesives polymerized via frontal polymerization. However, the scope of adhesives formed via frontal polymerization has been limited to a small range of materials and configurations. Therefore, it is desirable to develop adhesives that exhibit a longer shelf life that are applicable to a wide variety of substrates and geometrical configurations.

### SUMMARY

Disclosed herein is a composition comprising a first epoxide comprising a first glycidyl epoxide; a second epoxide comprising a second glycidyl epoxide and/or a non-glycidyl epoxide; wherein the first glycidyl epoxide is different from the second glycidyl epoxide; wherein the first and the second epoxide is cationically polymerizable. It further comprises an initiator and a filler, where the composition upon external stimulus undergoes an ionic polymerization reaction in a spatially propagating reaction front or in a global reaction that occurs throughout an entire composition. The viscosity of the composition is about 1 to 25,000 Pa·s as measured with a rheometer using a parallel plate fixture with 25 mm diameter plates at a strain rate sweep, frequency range of 0.01 to 10 Hz.

Disclosed herein is a method of manufacturing a composition comprising mixing together a mixture prepared from a composition comprising a first epoxide comprising a first glycidyl epoxide; a second epoxide comprising a second glycidyl epoxide and/or a non-glycidyl epoxide; wherein the first glycidyl epoxide is different from the second glycidyl epoxide; an initiator; and a filler. The method further comprises subjecting the mixture to an external stimulus and facilitating polymerization of the mixture.

### BRIEF DESCRIPTION OF THE DRAWINGS

FIG. 1 is a depiction of the proposed mechanism for the frontal polymerization of an epoxy, showing both thermal and UV initiation;

FIG. 2 is a depiction of a shear lag model used to calculate shear adhesion and stress distributions at failure;

FIG. 3A depicts the lap shear adhesion results; wherein shear stress is plotted against extension;

FIG. 3B depicts the results for shear stress distribution at failure;

FIG. 4 depicts the wire pull out testing schematic;

FIG. 5 depicts the wire pull out adhesion results; wherein shear stress is plotted against extension; and

FIG. 6 depicts the results for addition of fumed silica, where viscosity is plotted against the shear rate for the composition.

### DETAILED DESCRIPTION

Disclosed herein is a composition for an ionically frontal polymerizing system that contains two or more reactive species in a reaction mixture. The composition comprises two or more reactive species with an initiator blend that comprises two or more initiators. In an embodiment, the reaction mixture comprises a filler. In an exemplary embodiment, the respective reactants are polymerized upon external stimulus. The polymerized composition is such that the reactive species can facilitate crosslinking of the composition. In an embodiment, the amount of the filler in the reaction mixture can be varied to obtain a desired viscosity for the composition. The unreacted reaction mixture can be stored for up to 1 week, more preferably up to 1 month, and most preferably up to 1 to 2 years. In a preferred embodiment, the unreacted reaction mixture can be activated on demand.

The composition for producing the adhesive may be in the form of a liquid or in the form of a gel. A liquid composition preferably does not comprise a monomer that can undergo polymerization via free radical polymerization. The composition may also be devoid of a free radical initiator. The liquid composition contains only ionically polymerizable initiators and monomers.

The composition for producing gels (which are then frontally polymerized to form foams) comprises a combination of free radically polymerizable monomers and initiators in addition to the ionically polymerizable monomers and initiators. The free radically polymerizable monomers are preferably polymerized prior to the ionically polymerizable monomers thus producing the gel. The ionically polymerizable monomers are subsequently polymerized to produce the gel.

Disclosed herein too is a method for manufacturing articles from a composition for a frontally polymerizing system that contains two or more reactive species. The method involves mixing the two or more reactive species with an initiator that comprises two or more initiators and reacting the respective reactants using an external stimulus. In an exemplary embodiment, the composition is cured via heat energy applied externally to the composition. In another exemplary embodiment, the composition is cured using electromagnetic radiation, examples of which are ultraviolet radiation, microwave radiation, infrared radiation, or a combination thereof. The ability to cure the composition without having to submit the entire part assembly to a large oven, thermal blanket, or radiant heater is advantageous for flexible and efficient manufacturing of articles.

In an embodiment, the composition comprises a reaction mixture having two or more reactive species that can undergo polymerization reactions upon being subjected to an external stimulus. The composition is generally more stable when protected from UV radiation.

In another embodiment, the composition is also shelf stable— i.e., it can be stored for long periods of time (e.g., at room temperature or below in the preferred absence of UV radiation) such as, for example, up to 1 week, more preferably up to 1 month, and most preferably up to 1 to 2 years, without appreciable changes in composition or in viscosity. The shelf life is determined for a composition that is stored at a temperature of about 25° C. or lower, preferably at about 0° C. or lower, and more preferably at about −20° C. or lower. The composition can also be stable at a temperature higher than 25° C. (room temperature) and the stability above room temperature is dependent on the thermal initiators employed in the composition.

In an embodiment, the composition for the frontally polymerizing system comprises two or more different monomers comprising epoxides—a first epoxide and a second epoxide. In a preferred embodiment, the epoxide monomers have more than one epoxide group. The epoxide monomers are such that they can undergo ionic polymerization. Ionic polymerization may include cationic and/or anionic polymerization. In an embodiment, the monomers include epoxies (oxirane), thiiranes (episulfides), oxetanes, lactams, lactones, lactides, glycolides, tetrahydrofuran, or a mixture thereof. In a preferred embodiment, the monomers include aliphatic epoxides formed by the epoxidation of double bonds. The aliphatic epoxides can be cycloaliphatic epoxides. In a preferred embodiment, the monomers include aromatic epoxides formed by the epoxidation of phenols. The epoxide monomers can include functional groups, including, but not limited to the ethers, enol ethers, esters, and alcohols. In an embodiment, the epoxide monomers can be halogenated.

In an embodiment, the first epoxide and the second epoxide comprise a first glycidyl epoxide and/or a first non-glycidyl epoxide, while the second epoxide comprises a second glycidyl epoxide and/or a second non-glycidyl epoxide. In an embodiment, the first glycidyl epoxide is not the same as the second glycidyl epoxide when both glycidyl epoxides are used in the composition. In an embodiment, the first non-glycidyl epoxide may be the same as or different from the second non-glycidyl epoxide when both are used in the composition.

In an embodiment, it is desirable for the composition to contain a first epoxide that is a glycidyl epoxide and a second epoxide that is a non-glycidyl epoxide. In another embodiment, it is desirable for the composition to contain a first epoxide that is a glycidyl epoxide (a first glycidyl epoxide) and a second epoxide (a second glycidyl epoxide) that is also a glycidyl epoxide, where the first glycidyl epoxide is different from the second glycidyl epoxide.

In an embodiment, the first epoxide comprises a first glycidyl epoxide while the second epoxide comprises a second glycidyl epoxide and/or a non-glycidyl epoxide, where the first glycidyl epoxide is different from the second glycidyl epoxide. The terms “different” and “not the same as” implies that the two glycidyl epoxides or non-glycidyl epoxides are chemically different from one another, i.e., they have at least one atomic or molecular moiety that differs from the first glycidyl epoxide when compared with the second glycidyl epoxide.

The first epoxide and second epoxide may be monomers, dimers, trimers, quadramers, pentamers, and the like, all the way to oligomers and are preferably miscible with each other at reaction conditions. While it is desirable for the epoxide monomers to be compatible with each other, it is also possible to use epoxides that are semi-compatible or even incompatible with each other. Surfactants, block copolymers, and other compatibilizers may be added to the composition to bring about partial or complete miscibility between the first epoxide and the second epoxide.

The first epoxide monomers and the second epoxide monomers in the claimed composition are those that can be polymerized by ionic polymerization. In an embodiment, the first epoxide monomers and the second epoxide monomers may include aromatic, aliphatic or cycloaliphatic epoxy compounds. In an embodiment, the first epoxide monomer and the second epoxide monomer separately has at least one, preferably at least two, epoxy groups in each epoxide molecule.

In an embodiment, the first epoxide and the second epoxide monomers are glycidyl ethers and β-methylglycidyl ethers of aliphatic or cycloaliphatic diols or polyols, e.g., those of ethylene glycol, propane-1,2-diol, propane-1,3-diol, butane-,4-diol, diethylene glycol, polyethylene glycol, polypropylene glycol, glycerol, trimethylolpropane or 1,4-dimethylolcyclohexane, or of 2,2-bis(4-hydroxycyclohexyl) propane and N,N-bis(2-hydroxyethyl)aniline; the glycidyl ethers of di- and polyphenols, typically of resorcinol, for example, resorcinol diglycidyl ether, glycidyl ethers of 4,4′-dihydroxyphenyl-2,2-propane, of novolaks or of 1,1,2,2-tetrakis(4-hydroxyphenyl)ethane. Illustrative examples are phenyl glycidyl ether, p-tert-butyl glycidyl ether, o-icresyl glycidyl ether, polytetrahydrofuran glycidyl ether, n-butyl glycidyl ether, 2-ethylhexyl glycidyl ether, C₁₂₋₁₅ alkyl glycidyl ether, cyclohexanedimethanol diglycidyl ether. Other examples are N-glycidyl compounds, typically the glycidyl compounds of ethylene urea, 1,3-propylene urea or 5-dimethylhydantoin or of 4,4′-methylene-5,5′-tetramethyidi-hydantoin, or e.g., triglycidyl isocyanurate.

In an embodiment, the first epoxide monomer and the second epoxide monomer is aliphatic in nature, for example, a cycloaliphatic glycidyl ether, also known as EPON 1510.

In yet another embodiment, the first epoxide monomers and the second epoxide monomers may be the glycidyl esters of carboxylic acid, preferably di- and polycarboxylic acids. Typical examples are the glycidyl esters of succinic acid, adipic acid, azelaic acid, sebacic acid, phthalic acid, terephthalic acid, tetra- and hexa-hydrophthalic acid, isophthalic acid, trimellitic acid, or of dimerized fatty acids, or the like, or a combination thereof

Additional exemplary first epoxide monomers and second epoxide monomers include epoxy, glycidyl ether and epoxycyclohexyl functional siloxanes and siloxane derivatives such as epoxypropoxypropyl terminated polydimethylsiloxanes and 1,3-bis[2-(3,4-epoxycyclohexyl) ethyl] tetramethyldisiloxane.

Examples of suitable first epoxide monomers and second epoxide monomers are diglycidyl ether of bisphenol A, diomethane diglycidyl ether, 2,2-bis(4-glycidyloxyphenyl)propane, 2,2′-((1-methylethylidene)bis(4,1-phenyleneoxymethylene))bisoxirane, 2,2-bis(4-(2,3-epoxypropyloxy)phenyl)propane, 2,2-bis(4-hydroxyphenyl)propane, diglycidyl ether, 2,2-bis(p-glycidyloxyphenyl)propane, 4,4′-bis(2,3-epoxypropoxy)diphenyldimethylmethane, 4,4′-dihydroxydiphenyldimethylmethane diglycidyl ether, 4,4′-isopropylidenebis(1-(2,3-epoxypropoxy)benzene), 4,4′-isopropylidenediphenol diglycidyl ether, bis(4-glycidyloxyphenyl)dimethylmethane, bis(4-hydroxyphenyl)dimethylmethane diglycidyl ether, diglycidyl ether of bisphenol F, 2-(butoxymethyl)oxirane, the reaction product of 2-(chloromethyl)oxirane and 4-[2-(4-hydroxyphenyl)propan-2-yl]phenol also known as bisphenol A-epichlorohydrin based epoxy, modified bisphenol A epichlorohydrin based epoxy, diglycidyl 1,2-cyclohexanedicarboxylate, 1,4-cyclohexanedimethanol diglycidyl ether, a mixture of cis and trans 1,4-cyclohexanedimethanol diglycidyl ether, neopentyl glycol diglycidyl ether, resorcinol diglycidyl ether, 4,4′-methylenebis(N,N-diglycidylaniline), 3,4-epoxycyclohexylmethyl 3,4-epoxycyclohexanecarboxylate, 3,4-epoxy-1-cyclohexanecarboxylic acid, 3,4-epoxycyclohexan-1-yl)methyl ester, tert-butyl glycidyl ether, 2-ethylhexyl glycidyl ether, epoxypropoxypropyl terminated polydimethylsiloxanes, neopentyl glycol diglycidyl ether, 1,4-cyclohexanedimethanol diglycidyl ether, 1,3-bis[2-(3,4-epoxycyclohexyl)ethyl]tetramethyldisiloxane, trimethylolpropane triglycidyl ether, diglycidyl 1,2-cyclohexanedicarboxylate, or the like, or a combination thereof.

In a preferred embodiment, the first epoxide monomer and the second epoxide monomer are (different from each other) but are glycidyl epoxides comprising a cycloaliphatic epoxy compound. The different glycidyl monomers are shown below. In an embodiment, a useful glycidyl epoxide is a diglycidyl ether of bisphenol F, also known as Epon 862° and having the structure shown in the chemical formula (I)

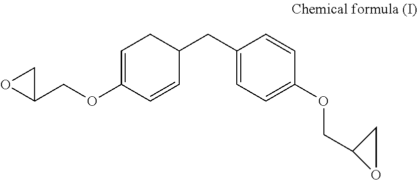 [SMILES: C1=CC(Cc2ccc(OCC3CO3)cc2)CC=C1OCC1CO1]

In another embodiment, the glycidyl epoxide is a modified diglycidyl ether of bisphenol F also known as a modified EPON 862° and having the structure shown in the chemical formula (II) below:

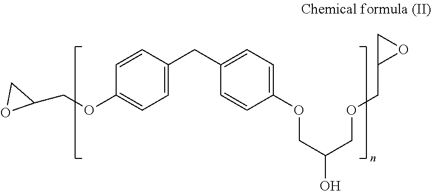

In the above chemical formula (II) n is the number of repeat units and can be an integer from 2 to 1000, preferably 3 to 500, and more preferably 4 to 200. The epoxy resin of the chemical formula (II) is produced by polymerizing bisphenol F with the EPON 862.

In yet another embodiment, the glycidyl epoxide may have the structure shown in the chemical formula (III) below:

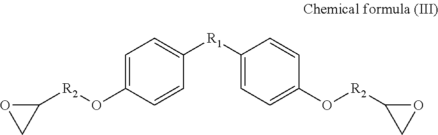

In the above chemical formula (III), R₁ is a single bond, —O—, —S—, —C(O)—, or a C₁₋₁₈ organic group. The C₁₋₁₈ organic bridging group may be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. In the Formula (6), R₂ is a C₁₋₃₀ alkyl group, a C₃₋₃₀ cycloalkyl, a C₆₋₃₀ aryl, a C₇₋₃₀ alkaryl, a C₇₋₃₀ aralkyl, a C₁₋₃₀ heteroalkyl, a C₃₋₃₀ heterocycloalkyl, a C₆₋₃₀ heteroaryl, a C₇₋₃₀ heteroalkaryl, a C₇₋₃₀ heteroaralkyl, a C₂₋₁₀ fluoroalkyl group, or a combination thereof.

Other exemplary variations of the chemical formula (III) that can be used are shown in the chemical formulas (IV) and (V). In an embodiment, one variation of the chemical formula (III) that may be used is shown in the chemical formula (IV) below.

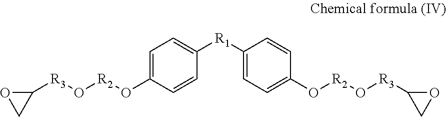

In the above chemical formula (IV), R₁ is detailed above in chemical formula (III), R₂ and R₃ may be the same or different and are independently a C₁₋₃₀ alkyl group, a C₃₋₃₀ cycloalkyl, a C₆₋₃₀ aryl, a C₇₋₃₀ alkaryl, a C₇₋₃₀ aralkyl, a C₁₋₃₀ heteroalkyl, a C₃₋₃₀ heterocycloalkyl, a C₆₋₃₀ heteroaryl, a C₇₋₃₀ heteroalkaryl, a C₇₋₃₀ heteroaralkyl, a C₂₋₁₀ fluoroalkyl group, or a combination thereof.

In an exemplary embodiment, a glycidyl epoxide having the structure of chemical formula (V) may be used in the composition.

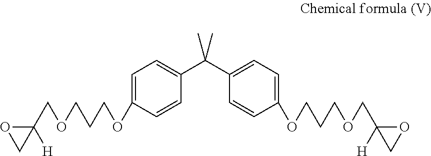 [SMILES: CC(C)(c1ccc(OCCCOCC2CO2)cc1)c1ccc(OCCCOCC2CO2)cc1]

In a preferred embodiment, the glycidyl epoxide is the reaction product of 2-(chloromethyl) oxirane and 4-[2-(4-hydroxyphenyl) propan-2-yl] phenol also known as bisphenol A-epichlorohydrin based epoxy (also known as bisphenol A diglycidyl ether) of the chemical formula (VI) below:

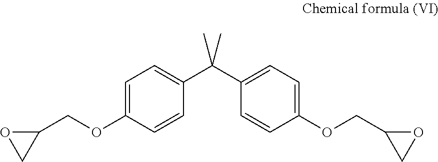 [SMILES: CC(C)(c1ccc(OCC2CO2)cc1)c1ccc(OCC2CO2)cc1]

The glycidyl epoxide of the chemical formula (VI) is commercially available as EPON 828. A polymeric version of the epoxy resin of the chemical formula (VI) is shown in chemical formula (VI A) and may also be used.

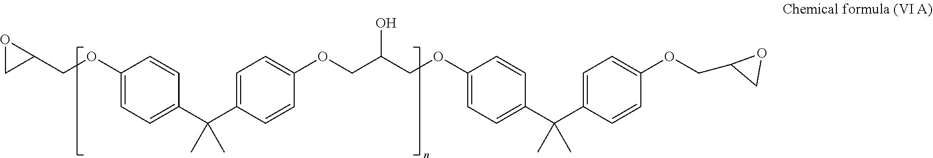

In the above chemical formula (VI A), n can be an integer of 2 to 1000, preferably 3 to 500, and more preferably 4 to 200.

When two different glycidyl monomers are used (as the first glycidyl monomer and the second glycidyl monomer, which are different from each other), the first glycidyl monomer is used in an amount of 1 wt % to 30 wt %, more preferably in an amount of 10 wt % to 25 wt %, and most preferably in an amount of 12 wt % to 20 wt %, based on the total weight of the composition, while the second glycidyl monomer is used in an amount of 1 wt % to 30 wt %, more preferably in an amount of 10 wt % to 25 wt %, and most preferably in an amount of 12 wt % to 20 wt %, based on the total weight of the composition.

In an embodiment, the total amount of the glycidyl epoxide is present in an amount of 1 wt % to 60 wt %, more preferably in an amount of 20 wt % to 50 wt %, and most preferably in an amount of 25 wt % to 40 wt %, based on the total weight of the composition.

The first and the second epoxide monomers can also be non-glycidyl epoxides. The first non-glycidyl epoxide and the second non-glycidyl epoxide monomers are different from each other and can also be polymerized by ionic polymerization. In an embodiment, the first and the second non-glycidyl epoxides are cycloaliphatic epoxides containing oxirane rings attached to their cyclic structures. In an embodiment, the cycloaliphatic epoxides can have functional groups like alkyl, alkenyl, vinyl, alkoxy, phenyl, or benzyl groups.

In a preferred embodiment, the cycloaliphatic epoxide used in the composition is not specifically limited as long as it contains two or more epoxy groups per molecule. The epoxy groups preferably each contain two carbon atoms constituting the alicyclic skeleton. In an embodiment, the first epoxide monomer may be a glycidyl epoxide monomer, while the second epoxide monomer may be a non-glycidyl epoxide monomer.

Examples of suitable epoxide monomers that can be used as the second epoxide monomer are represented by Chemical formulas VII (a) to VII (f)

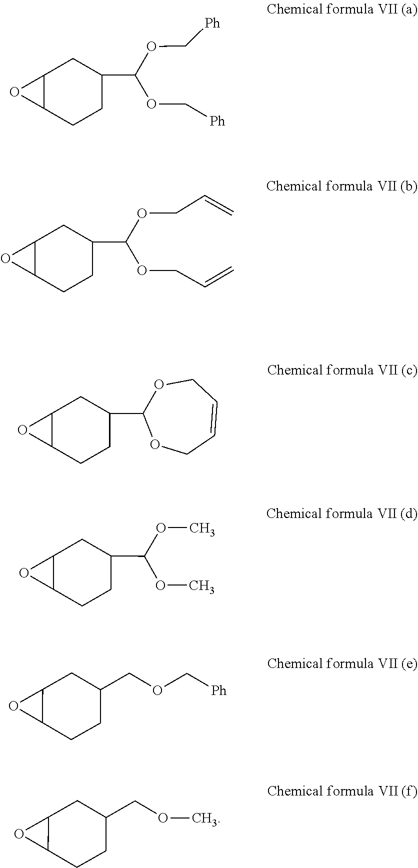 [SMILES: c1ccc(COC(OCc2ccccc2)C2CCC3OC3C2)cc1 ; C=CCOC(OCC=C)C1CCC2OC2C1 ; C1=CCOC(C2CCC3OC3C2)OC1 ; COC(OC)C1CCC2OC2C1 ; c1ccc(COCC2CCC3OC3C2)cc1 ; COCC1CCC2OC2C1]

In an embodiment, the first and/or second non-glycidyl epoxide is a monomer represented by Chemical Formula (VIII):

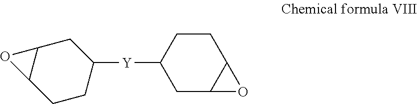

In Formula (VIII), Y represents a linkage group. Examples of Y are single bond, a divalent hydrocarbon group, carbonyl group (—CO—), ether bond (—O—), ester bond (—COO—), amide bond (—CONH—), carbonate bond (—OCOO—), and a group comprising two or more of these groups combined with each other. Preferred examples of the divalent hydrocarbon group are linear or branched alkylene groups and divalent alicyclic hydrocarbon groups typified by cycloalkylene groups, each of which has eighteen or less carbon atoms. The linear or branched alkylene groups include methylene, methylmethylene, dimethylmethylene, ethylene, propylene, and trimethylene groups. The divalent alicyclic hydrocarbon groups include 1,2-cyclopentylene, 1,3-cyclopentylene, cyclopentylidene, 1,2-cyclohexylene, 1,3-cyclohexylene, 1,4-cyclohexylene, and cyclohexylidene group.

In an embodiment, the first and second non-glycidyl epoxide monomer has two or more epoxide groups. Examples of suitable epoxides that can be used are bis(2,3-epoxycyclopentyl) ether, 1,2-bis (2,3-epoxycyclopentyloxy)ethane, 3,4-epoxycyclohexyl-methyl 3,4-epoxycyclohexanecarboxylate, 3,4-epoxy-6-methyl-cyclohexylmethyl 3,4-epoxy-6-methylcyclohexanecarboxylate, di(3,4-epoxycyclohexylmethyl)hexanedioate, di(3,4-epoxy-6-methylcyclohexylmethyl) hexanedioate, ethylenebis(3,4-epoxycyclohexanecarboxylate, ethanediol di(3,4-epoxycyclohexylmethyl)ether, vinylcyclohexene dioxide, dicyclopentadiene diepoxide or 2-(3,4-epoxycyclohexyl-5,5-spiro-3,4-epoxy)cyclohexane-1,3-dioxane, 2,2′-Bis-(3,4-epoxy-cyclohexyl)-propane or the like, or a combination thereof.

In yet another exemplary embodiment, the non-glycidyl epoxide is a monomer represented by the following compounds having Chemical Formulas shown in IX (a) to IX (g), wherein the number of repeat units n denotes an integer of 1 to 30.

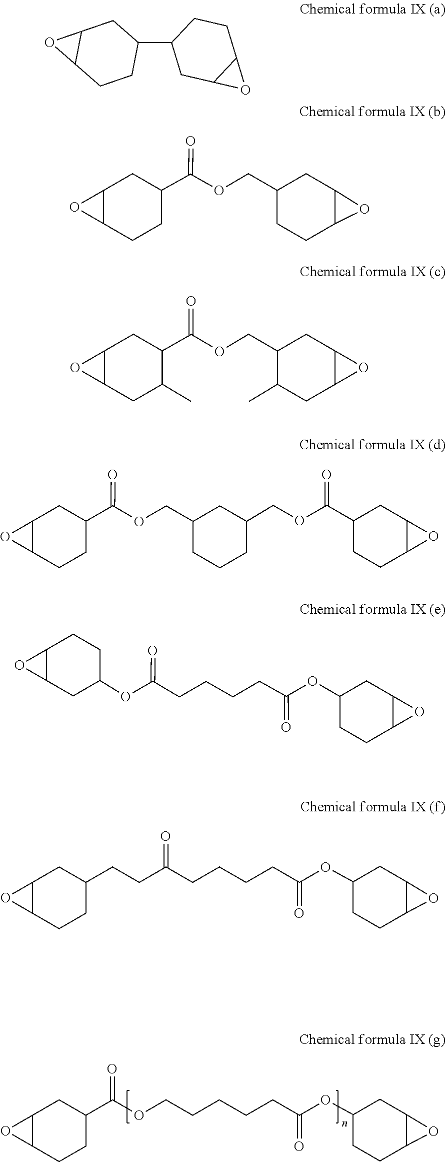

In a preferred embodiment, the non-glycidyl epoxide is 3,4-epoxycyclohexylmethyl-3′,4′-epoxycyclohexane carboxylate represented by the Chemical formula (X) below:

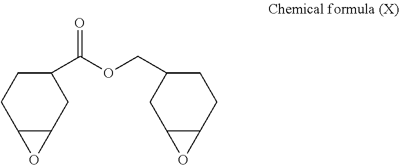 [SMILES: O=C(OCC1CCC2OC2C1)C1CCC2OC2C1]

When two different non-glycidyl epoxide monomers are used (as the first non-glycidyl epoxide monomer and the second non-glycidyl epoxide monomer, which are different from each other), the first non-glycidyl epoxide monomer is used in an amount of 20 wt % to 40 wt %, more preferably in an amount of 25 wt % to 35 wt %, and most preferably in an amount of 28 wt % to 33 wt %, based on the total weight of the composition, while the second non-glycidyl epoxide monomer is used in an amount of 20 wt % to 40 wt %, more preferably in an amount of 25 wt % to 35 wt %, and most preferably in an amount of 28 wt % to 33 wt %, based on the total weight of the composition.

In an embodiment, the first non-glycidyl epoxide and/or the second non-glycidyl epoxide are present in a combined amount of 40 wt % to 75 wt %, more preferably in an amount of 50 wt % to 65 wt %, and most preferably in an amount of 55 wt % to 60 wt %, based on the total weight of the composition.

In a preferred embodiment, the first epoxide comprises a first glycidyl epoxide and the second epoxide comprises a second glycidyl epoxide and/or a non-glycidyl epoxide, where the first glycidyl epoxide is different than the second glycidyl epoxide.

The composition further contains an initiator blend that contains two or more initiators namely a first initiator that comprises at least one free radical initiator and a second initiator that comprises at least one cationic initiator. The initiator blend may further contain at least one ionic accelerator. In an embodiment, the at least one ionic accelerator is a cationic accelerator or an anionic accelerator.

In a preferred embodiment, the initiators may be present in the form of an initiator blend comprising an initiator and a co-initiator. The initiators may be photoinitiators, thermal initiators, or a combination thereof. In some embodiments, photoinitiators can be thermal initiators or vice-versa depending upon the initiation or polymerization temperature of the low molecular weight molecules. A thermal radical generator may be added if desired. The thermal radical generator dissociates under heat to produce radicals that aid in the oxidation of the ionic initiator.

In a preferred embodiment, the at least one ionic accelerator is a cationic accelerator. The cationic accelerator may be a thermal radical generator that can facilitate frontal polymerization.

In general, a radical initiator generates radicals upon activation that promote polymerization of the monomers. In the case of photoinitiators, the activation energy is derived primarily from electromagnetic radiation (e.g., ultraviolet light, visible light, xrays, electrons, protons, or a combination thereof) while in the case of thermal initiators, the activation energy is derived from heat (e.g., conduction or convection) or electromagnetic radiation that involves the generation of heat (e.g., infrared radiation, microwave radiation, or a combination thereof). Induction heating may also be used.

In a preferred embodiment, a suitable cationic initiator may be used. Exemplary cationic initiators are onium salts containing a SbF₆, PF₆, BF₄, AlO₄Cl₂F₃₆ or a C₂₄BF₂₀ anion.

Examples of suitable cationic initiators for reacting the epoxy resins are bis(4-hexylphenyl)iodonium hexafluoroantimonate, bis(4-hexylphenyl)iodonium hexafluorophosphate, (4-hexylphenyl)phenyliodonium hexafluoroantimonate, (4-hexylphenyl)phenyliodonium hexafluorophosphate, bis(4-octylphenyl)iodonium hexafluoroantimonate, [4-(2-hydroxytetradecyloxy)phenyl]phenyl iodonium hexafluoroantimonate, [4-(2-hydroxydodecyloxy)phenyl]phenyliodonium hexafluoroantimonate, bis(4-octylphenyl)iodonium hexafluorophosphate, (4-octylphenyl)phenyliodonium hexafluoroantimonate, (4-octylphenyl)phenyliodonium hexafluorophosphate, bis(4-decylphenyl)iodonium hexafluoroantimonate, bis(4-decylphenyl)iodonium hexafluorophosphate, (4-decylphenyl)phenyliodonium hexafiuoroantimonate, (4-decylphenyl)phenyliodonium hexafluorophosphate, (4-octyloxyphenyl)phenyliodonium hexafluoroantimonate, (4-octyloxyphenyl)phenyliodonium hexafluorophosphate, (2-hydroxydodecyloxyphenyl)phenyliodonium hexafluoroantimonate, (2-hydroxydodecyloxyphenyl)phenyliodonium hexafluorophosphate, bis(4-hexylphenyl)iodonium tetrafluoroborate, (4-hexylphenyl)phenyliodonium tetrafluoroborate, bis(4-octylphenyl)iodonium tetrafluoroborate, (4-octylphenyl)phenyliodonium tetrafluoroborate, bis(4-decylphenyl)iodonium tetrafluoroborate, bis(4-(mixed C₈-C₄alkyl)phenypiodonium hexafluoroantimonate, (4-decylphenyl)phenyliodonium tetrafluoroborate, (4-octyloxyphenyl)phenyliodonium tetrafluoroborate, (2-hydroxydodecyloxyphenyl)phenyliodonium tetrafluoroborate, biphenylene iodonium tetrafluoroborate, biphenylene iodonium hexafluorophosphate, biphenylene iodonium hexafluoroantimonate, bis(4-tert-butylphenyl)iodonium perfluoro-1-butanesulfonate electronic grade, bis(4-tert-butylphenyl)iodonium p-toluenesulfonate electronic grade, (p-isopropylphenyl)(p-methylphenyl)iodonium tetrakis(pentafluorophenyl) borate, bis(4-tert-butylphenyl)iodonium triflate electronic grade, boc-methoxyphenyldiphenylsulfonium triflate, (4-tert-butylphenyl)diphenylsulfonium triflate, diphenyliodonium hexafluorophosphate, diphenyliodonium nitrate, diphenyliodonium perfluoro-1-butanesulfonate electronic grade, diphenyliodonium p-toluenesulfonate, diphenyliodonium triflate electronic grade, (4-fluorophenyl)diphenylsulfonium triflate, N-hydroxy-5-norbornene-2,3-dicarboximide perfluoro-1-butanesulfonate, (4-iodophenyl)diphenylsulfonium triflate, (4-methoxyphenyl)diphenylsulfonium triflate, 2-(4-methoxystyryl)-4,6-bis(trichloromethyl)-1,3,5-triazine, (4-methylphenyl)diphenylsulfonium triflate, (4-methylthiophenyl)methyl phenyl sulfonium triflate, 1-naphthyl diphenylsulfonium triflate, (4-phenoxyphenyl)diphenylsulfonium triflate, (4-phenylthiophenyl)diphenylsulfonium triflate, triarylsulfonium hexafluoroantimonate salts, triarylsulfonium hexafluorophosphate, triphenylsulfonium perfluoro-1-butanesufonate, diphenyliodonium tetrakis(perfluoro-t-butyloxy)aluminate or the like, or a combination thereof. An exemplary cationic initiator is p-(octyloxyphenyl)phenyliodonium hexafluoroantimonate.

In another embodiment, a coinitiator comprising organic and inorganic compounds can be used. In accordance with the embodiments of the present invention the coinitiator used in the compositions is not specifically limited as long as it can undergo homolytic fission to generate free radicals.

In an embodiment, coinitiators include azo compounds, inorganic peroxides, organic peroxides, or the likes, or combinations thereof. In an embodiment, more than one coinitiator can be used.

Examples of suitable coinitiators for reacting the epoxy resins are tert-butyl hydroperoxide, tert-butyl peracetate, cumene hydroperoxide, 2,5-di(tert-butylperoxy)-2,5-dimethyl-3-hexyne, dicumyl peroxide, 2,5-bis(tert-butylperoxy)-2,5-dimethylhexane, 2,4-pentanedione peroxide, 4-hydroxy-4-methyl-2-pentanone, N-methyl-2-pyrrolidone, 1,1-bis(tert-butylperoxy)-3,3,5-trimethylcyclohexane, 1,1-bis (tert-butylperoxy)cyclohexane, 1,1-bis(tert-amylperoxy)cyclohexane, butanone peroxide, tert-butyl peroxide, lauroyl peroxide, tert-butyl peroxybenzoate, tert-butylperoxy 2-ethylhexyl carbonate, tert-butyl hydroperoxide, 4,4′-azobis(4-cyanovaleric acid, 1,1′-azobis(cyclohexanecarbonitrile), azobisisobutyronitrile, 2,2′-azobis(2-methylpropionamidine) dihydrochloride, 2,2′-azobis(2-methylpropionitrile), 2,2′-azobis(2-methylpropionitrile) recrystallized from methanol, ammonium persulfate, hydroxymethanesulfinic acid monosodium salt dihydrate, potassium persulfate, sodium persulfate or the like, or a combination thereof. In an embodiment, the coinitiator is 1,1,2,2-tetraphenyl-1,2-ethanediol.

In a preferred embodiment, the initiator used are individually present in an amount of 0.5 to 5 wt %, preferably 1 to 3 wt % and more preferably 1.5 to 2.5 wt %, based on the total weight of the composition.

In an embodiment, the composition for the frontally polymerizing system may comprise fillers. In the claimed composition, the objective of the filler is to vary or determine the chemical, physical and mechanical properties of the composition. The fillers are used to adjust the viscosity of the composition. The filler content of the composition can be adjusted to arrive at a viscosity that permits use of the composition in situations where dams, gates and boundaries are not desirable. For example, the composition without filler has such as low viscosity that it cannot be applied to a surface without spreading over the portions of the surface where it is not desired. Adding a filler as a viscosity modifier can prevent such uncontrolled flow and thus permit a better handling of the filler.

The filler can be particulate like or fibrous in its geometry. Both articulate and fibrous fillers may be organic or inorganic fillers. Particulate fillers have a radius of gyration of 2 nanometers to 10 micrometers, preferably 10 nanometers to 5 micrometers, and more preferably 20 nanometers to 1 micrometer. Fibrous fillers can have a diameter of 2 nanometers to 10 micrometers and preferably 10 nanometers to 5 micrometers. Fibrous fillers preferably have aspect ratios (length to diameter) of greater than 5, preferably greater than 10 and more preferably greater than 100.

Examples of fillers that can be used are aluminum powder, alumina trihydrate, barium sulfate, silicates, calcium carbonate, kaolin clay, glass spheres, copper, talc, aluminum oxide, titanium oxide, carbon fibers, organic fibers, or the like, or combinations thereof In an embodiment, more than one different type of filler can be used. In one preferred embodiment, the filler used is silica. In another embodiment, the composition may not comprise fillers.

In a preferred embodiment, the filler used is silica nanoparticles, such as for example, fumed silica. The silica nanoparticles are individually present in an amount of 0.1 to wt %, preferably 0.5 to 5 wt % and more preferably 2.5 to 3.5 wt %, based on the total weight of the composition.

In another embodiment, the filler used are glass spheres, hollow glass spheres, or a combination thereof. The glass spheres or hollow glass spheres are used in an amount of to 10 wt %, preferably 0.5 to 4 wt % and more preferably 2.5 to 3.5 wt %, based on the total weight of the composition.

Organic fillers may be in particulate or in fibrous form. Organic polymeric fillers may be selected from among polyolefins, poly(meth)acrylates, polyesters, polyamides, polyarylates, polyurethanes, or the like, or a combination thereof. Polymers can be homopolymers or block copolymers. In a preferred embodiment, the polymer fillers are miscible in the first and the second epoxide monomers. By selecting polymers that have lower melting points or lower glass transition temperatures than the temperature of the frontally polymerizing composition, the polymeric fibers may be melted or softened during the frontal polymerization process. This can cause a size redistribution of the fillers after polymerization compared with that before polymerization.

In an embodiment, the block copolymers can be a diblock or a triblock. Exemplary polymers include polymethylmethacrylate (PMMA), polystyrene-block-polybutadiene-block-poly(methyl methacrylate) or styrene-butadiene-styrene block copolymer.

In a preferred embodiment, the filler used is present in an amount of 0.5 to 10 wt %, preferably 3 to 7 wt % and more preferably 4 to 6 wt %, based on the total weight of the composition. In yet another embodiment, the filler is present up to 30 wt %, based on the total weight of the composition.

The composition may also contain additional ingredients such as crosslinking agents, hardeners, reactive or non-reactive diluents, fillers, fibers, chain transfer agents, UV stabilizers, UV absorbers, dyes, anti-ozonants, thermal stabilizers, inhibitors, viscosity modifiers, plasticizers, solvents, polymers, phase separating agents or the like, or a combination thereof. The composition may be devoid of solvents or diluents if desired.

In a preferred embodiment, the foregoing polymers (which are formed upon activation by an external stimulus) are present in linear, branched or crosslinked form following polymerization. In an embodiment, the foregoing polymers are present in crosslinked form following polymerization.

Diluents may also be used in the composition. The diluents may be reactive (i.e., they can react with the low molecule weight molecules to be a part of the network) or be non-reactive. Examples of suitable diluents are alcohols, ethyl vinyl ether, n-butyl vinyl ether, isobutyl vinyl ether, octadecyl vinyl ether, cyclohexyl vinyl ether, dihydroxybutane divinyl ether, hydroxybutyl vinyl ether, cyclohexane dimethanol monovinyl ether, diethyleneglycol divinyl ether, triethyleneglycol divinyl ether, n-propylvinyl vinyl ether, isopropyl vinyl ether, dodecyl vinyl ether, diethyleneglycol monovinyl ether, cyclohexane dimethanol divinyl ether, trimethylolpropane trivinyl ether and vinyl ether, which can be obtained, for example, by the addition of acetylene to alcohols, as well as oligomers and polymers, which contain vinyl ether groups and are obtained, for example, by the addition of acetylene to hydroxyl group-containing oligomers and/or polymers or by the reaction of alkyl vinyl ethers with reactive monomers, oligomers and/or polymers, especially by the reaction of isocyanates and isocyanate prepolymers with hydroxy-functional alkyl vinyl ethers.

In an embodiment, the diluent may be a polymer. Suitable polymers are thermoplastic polymers. Any of the polymers listed above may be used as a diluent, if so desired. The polymers generally have a weight average molecular weight of greater than 10,000 grams per mole, preferably greater than 15,000 grams per mole, and more preferably greater than 20,000 grams per mole.

In an embodiment, in one method of manufacturing an article, the composition for the frontally polymerizing system is prepared by mixing the mixing the two or more reactive species (e.g., the first epoxide and the second epoxide) with an initiator blend that comprises two or more initiators and a filler. The mixing of the reactants can be conducted in a reduced light environment and at a temperature conducive to dissolving the respective components. In a preferred embodiment, the mixing of the respective reactants continues until the mixture is homogenized.

In an embodiment, an external stimulus comprising electromagnetic radiation is used to activate the initiator within the homogenized mixture and to promote polymerization of the mixture. The electromagnetic radiation may be Xray, electron beam, microwave, ultraviolet, visible, infrared radiation, or a combination thereof. UV radiation is preferred.

In a preferred embodiment, a 200 W UV lamp is used with a 250 to 450 nm wavelength filter. The intensity of the UV radiation is between 1 to 19 W/cm², most preferably the intensity between 9 to 10 W/cm².

In a preferred embodiment, the external stimulus is heat energy. The external stimulus activates the initiator within the homogenized mixture and promotes polymerization of the mixture. The polymerization occurs between 200 to 250° C. The maximum temperature attained by the reaction front is about 180 to 300° C., more preferably 210 to 280° C. and most preferably 225 to 250° C.

As noted above, the adhesive can be manufactured from a liquid composition or from a gelled composition. The gelled composition contains free radically polymerizable monomers in addition to the ionically polymerizable monomers (which are ionically polymerized to produce the adhesive). The free radically polymerizable monomers may be acrylates or fluoroacrylates. At least one or more of the acrylates used as a free radical polymerizable monomer has a functionality of greater than 2 or preferably greater than 3.

Examples of acrylates are bisphenol A glycerolate diacrylate, bisphenol A ethoxylate diacrylate, bisphenol A dimethacrylate, bisphenol A ethoxylate dimethacrylate, isobornyl acrylate (IA), tertiary butyl acrylate, tertiary butyl methacrylate (TBMA), trimethylolpropane triacrylate, pentaerythritol triacrylate, tetrahydrofurfuryl acrylate, tetrahydrofurfuryl methacrylate, or the like, or a combination thereof.

The acrylates are added to the composition in an amount of 1 to 15 weight percent, based on a total weight of the composition.

The gel composition may also contain a free radical initiator. The free radical initiators can be co-initiators—i.e., they can serve as initiators for the ionically polymerizable monomers too. An example of a free radical initiator for manufacturing of the gel foam is diphenyl(2,4,6-trimethylbenzoyl)phosphine oxide (TPO).

A desired article can be made by the homogenized composition. The homogenized composition can be applied on a substrate or be disposed in a mold and subjected to an external stimulus. The homogenized composition can be applied to the substrate using any known method in the art including but not limited to application by hand, spraying, or employing a mechanical applicator. The substrate can comprise organic and inorganic substrates. For example, polymer, glass, wood, metal or metal alloys. In an embodiment, the polymer can be a homopolymer or a copolymer comprising polycarbonates, polyacrylates, or polyolefins. In an embodiment, the wood is not particularly limited and includes natural and plywood. In an embodiment, the metal comprises copper, aluminum, iron, or alloys thereof.

The composition and the method of manufacturing disclosed herein are exemplified by the following non-limiting examples.

### EXAMPLES

### Example 1

This example demonstrates the polymerization of a mixture of a non-glycidyl epoxide and a second glycidyl epoxide via frontal polymerization. The example uses a composition that comprises p-(octyloxyphenyl) phenyliodonium hexafluoroantimonate (IOC8 SbF6), 1,1,2,2-tetraphenyl-1,2-ethanediol (TPED), 3,4-epoxycyclohexanecarboxylate (ECC), and bisphenol A diglycidyl ether (DGEBA). This example was also used to demonstrate the utility of the composition as an adhesive for polymeric substrates such as polypropylene.

The initiator system contains a free radical photoinitiator to crosslink the monomers. In this embodiment the cationic initiator is an onium salt derivative. All of these components are soluble and can be mixed together and stored at room temperature under conditions where the composition is not exposed to light. To ensure homogenization of the mixture, the mixture is heated between 55 to 65° C. for an hour. When polymerization is desired, a heat source is applied to initiate frontal polymerization of the epoxy monomers. The frontal polymerization travels through the material beginning at the point of heat application. The composition used in this example can be stored for about a week. The materials used in the reaction are listed in the Table 1 below.

TABLE I
Adhesive resin formulation compositions

| Component | Function | Mass (%) |
|---|---|---|
| IOC8 SbF6 | Cationic Initiator | 2.00 |
| TPED | Co-initiator | 2.00 |
| ECC | Monomer | 57.60 |
| DGEBA | Monomer | 38.40 |

In this example, a resin composition was prepared with the reactants of Table 1. This composition can be stored for extended periods of time. In this composition, IOC8 SbF6 and TPED was dissolved in ECC by mixing at 60° C. for approximately 1 hour. DGEBA was added to the homogenized mixture. The mixture was further mixed for an hour at 60° C. The polymerization was initiated by an external UV radiation source. The polymerized front travels through the mixture beginning at the point of heat application.

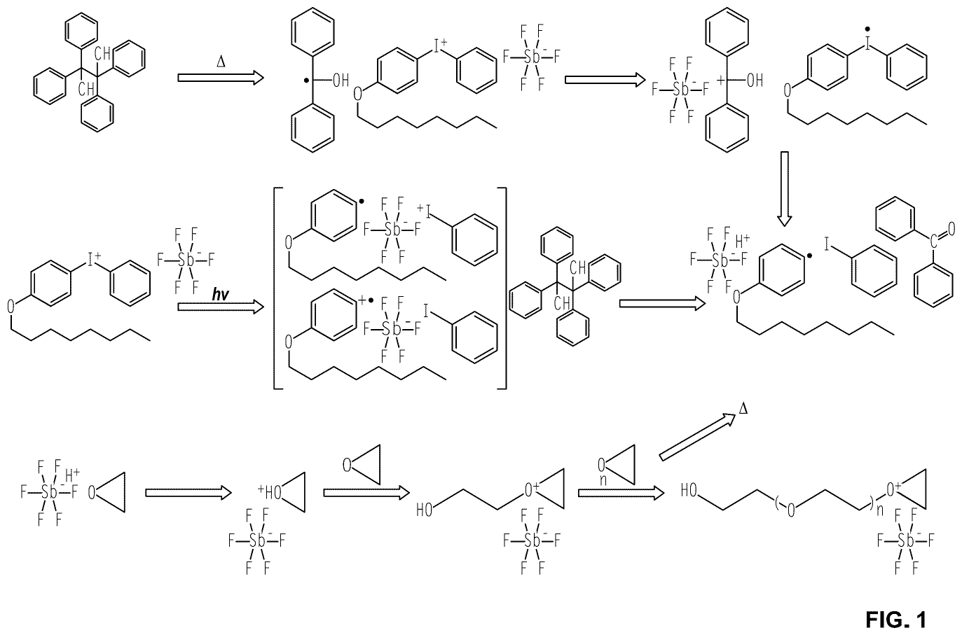

An exemplary frontal polymerization scheme is shown in FIG. 1. In FIG. 1, benzopinacol is used as a radical generator (a co-initiator used in the demonstrated embodiment) that undergoes heat dissociation and the resulting radicals formed aid in the oxidation of the cationic initiator. Additionally, a proton from the radical generator is also suspected to transfer to the metal complex of the cationic initiator and this results in the formation of the activated protonic acid which is depicted to initiate the curing of the epoxy system. The front is propagated from the heat released during the ring opening of the epoxy molecules, which is sufficient to dissociate the radical generator in the surrounding material and continue the propagating chain reaction. FIG. 1 shows that it is be possible to initiate the frontal polymerization either with heat or with UV radiation. In the demonstrated embodiment (Example 1) heat was used.

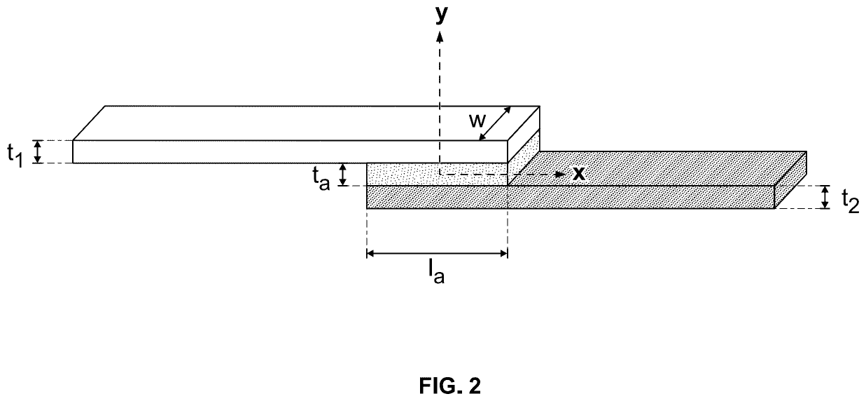

Adhesion testing to a variety of substrates was performed using a lap shear configuration where stress distributions at failure were calculated using a shear lag model. This model was utilized to enable such calculations while adhering two substrates with different material properties. This allowed for configurations in all cases where one substrate was transparent and exhibited remarkable adhesion thereby promoting failure at the other material interface. Consequently, both in-situ monitoring of frontal polymerization as well as adhesive strength measurements of various substrates was facilitated. A schematic of this configuration is depicted in FIG. 2 and accompanying equations of the shear lag model are described below.

$$τ = {C}_{1} cosh ( ωχ ) + {C}_{2} sinh ( ωχ ) \qquad ( 1 )$$

$${C}_{1} = \frac{P ω}{2 wl} [ \frac{1}{sinh ( \frac{ω}{2} )} ] \qquad ( 2 )$$

$${C}_{2} = ( \frac{ψ - 1}{ψ + 1} ) \frac{P ω}{2 wl} [ \frac{1}{cosh ( \frac{ω}{2} )} ] \qquad ( 3 )$$

$${ω}^{2} = ( 1 + ψ ) ϕ \qquad ( 4 )$$

$$ψ = \frac{{E}_{1} {t}_{1}}{{E}_{2} {t}_{2}} \qquad ( 5 )$$

$$ϕ = \frac{{Gl}^{2}}{{E}_{1} {t}_{1} {t}_{a}} \qquad ( 6 )$$

$$χ = \frac{x}{l} \qquad ( 7 )$$

$$τ = \frac{P}{π DL} \qquad ( 8 )$$

In FIG. 2, P is the load at failure, 1 is the adhesive overlap length, tₐ is the adhesive thickness, G is the adhesive shear modulus, E_{1&2} are Young's moduli of substrates 1 and 2, respectively, t_{1&2} are thicknesses of substrates 1 and 2, respectively, and W is the specimen width.

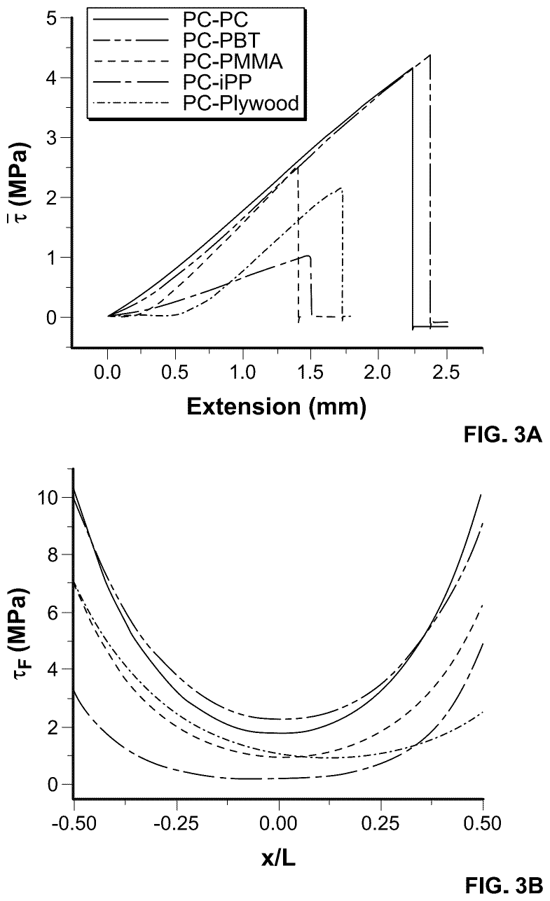

FIG. 3A and FIG. 3B demonstrate the lap shear stress results. In this test, the composition is Example 1 is applied over a polycarbonate substrate and its adhesion is studied against polycarbonate, polybutylene terephthalate, polymethylmethacrylate, isotactic polypropylene and plywood. In FIG. 3A, the applied stress is plotted against the extension in millimeters. It can be seen from FIG. 3A, adhesion with all the test surfaces is obtained. Testing was conducted at a crosshead speed of 1 mm/min. With increasing load, maximum extension is achieved on a polybutylene terephthalate surface. Similar results are obtained in a shear stress distribution model as shown in FIG. 3B. The results from FIG. 3A and FIG. 3B are tabulated in Table II below.

TABLE II

| Substrate | τ̅ (MPa) | τₘₐₓ (MPa) |
|---|---|---|
| Polycarbonate* | 4.61 ± 0.73 | 11.04 ± 0.68 |
| Polybutylene terephthalate* | 4.38 ± 0.003 | 10.03 ± 0.03 |
| Polymethylmethacrylate | 2.41 ± 0.08 | 6.73 ± 0.23 |
| Isotactic Polypropylene | 1.03 ± 0.01 | 5.25 ± 0.24 |
| Plywood | 2.08 ± 0.03 | 6.93 ± 0.09 |

In the Table II, τ̅ is the average shear strength and τₘₐₓ is the maximum shear stress at failure. (*) next to the substrate label indicates the mechanism by which the substrate failed (i.e., whether the failure was cohesive or adhesive failure. Failure in the adhesive is termed adhesive failure. Failure in the substrate is termed cohesive failure. Therefore, tabulated strength values in these cases are of lower bound.

It is demonstrated by the lap shear adhesion results that the composition of Example 1 can adhere to various substrates. The average shear strength of the composition when bonded to a substrate is about 0.5 MPa to 10 MPa, preferably 1 to 5 MPa.

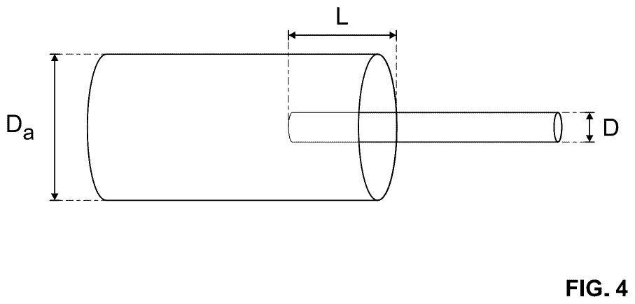

Specimens were also prepared where a metal wire was immersed in the composition of Example 1 and encapsulated in a cylindrical test tube, as shown in FIG. 4. Following polymerization, pull-out testing was performed, and shear stress was calculated using equation (8).

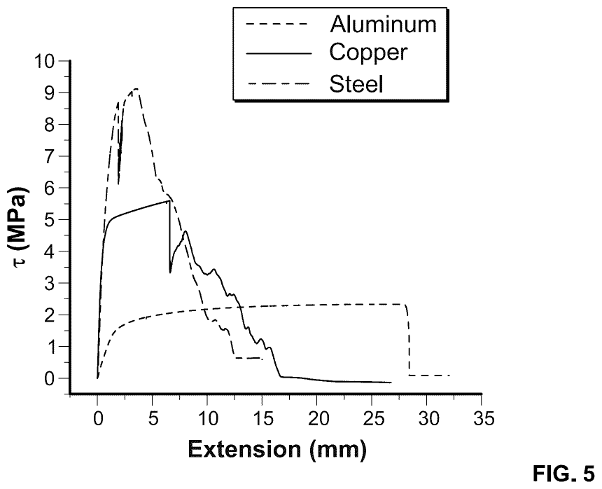

FIG. 5 demonstrates the wire pull out testing results. This experiment was conducted at a crosshead speed of 2 mm/min. The wires tested are aluminum, copper and steel. Upon curing, the adhesion of metal wires is studied. In FIG. 5, the applied stress is plotted against the extension in millimeters. It can be seen from FIG. 4 that adhesion is obtained with metal surfaces. The results from FIG. 5 are tabulated in Table III below.

TABLE III

| Wire | τ (MPa) |
|---|---|
| Aluminum | 2.24 ± 0.05 |
| Copper | 5.67 ± 0.19 |
| Steel | 8.93 ± 0.83 |

### Example 2

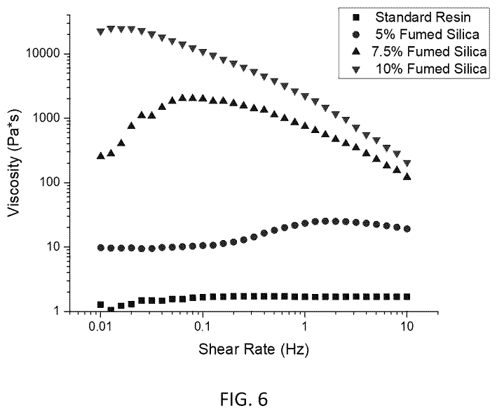

In this example, 14 nm fumed silica particles were added to the adhesive resin from Example 1 in concentrations of 5, 7.5, and 10 wt %. Shortly, the reaction mixture is prepared where the amount of ECC is about 53 wt % and the amount of DGEBA is about 36 wt %. The initiator, IOC8 SbF6 was used in an amount of 1.9 wt % and TPED (co-initiator) was used in an amount of 1.9 wt %. Resin viscosity was measured in a rheometer using a parallel plate fixture. Results are plotted in FIG. 6 and zero shear viscosities are tabulated in Table IV.

TABLE IV

| Resin | Zero Shear Viscosity (Pa · s) |
|---|---|
| Standard | 1.70 |
| 5% Fumed Silica | 9.60 |
| 7.5% Fumed Silica | 1,700 |
| 10% Fumed Silica | 24,700 |

The results show that fumed silica dramatically increased the resin viscosity, forming a “paste-like” adhesive. In contrast to the standard resin of Example 1, the silica-modified resins demonstrate more practicality as confinement is not required when applying the resin between interfaces. It was also observed that volatile formation during frontal polymerization of the modified resins was drastically reduced in comparison to the standard resin of Example 1. Additionally, lap shear adhesion testing was performed between two polycarbonate substrates using the resin with 5% fumed silica. Frontal polymerization was successful under the buried interfaces and substrate failure was observed, indicating that the additive did not negatively impact the adhesive strength.

### Example 3

In this Example, 6.75% fumed silica and 10% isotactic polypropylene powder by mass was added to the formulation in Example 1. Shortly, the reaction mixture is prepared where the amount of ECC is about 48 wt % and the amount of DGEBA is about 32 wt %. The initiator, IOC8 SbF6 was used in an amount of 1.63 wt % and TPED (co-initiator) was used in an amount of 1.63 wt %.The resin was then placed in a glass test tube, where polymerization was initiated by UV light from the bottom of the test tube. Following polymerization, the cured material was observed to be free of defects. It was concludede that the dilution of the exothermic components as well as the possible melting of isotactic polypropylene (iPP) particles may have prevented volatalization of formulation components.

### Example 4

In this example, frontal resin was prepared using the initiators and their concentration mentioned in example 1 and as depicted in Table V below. In this example, frontal resin is prepared using EPON 862 (100 wt %) or EPON 862+Resorcinol diglycidyl ether(90 wt %+10 wt %) or EPON 862+Resorcinol diglycidyl ether (70 wt %+30 wt %) or EPON 862+Resorcinol diglycidyl ether(50 wt %+50 wt %) as shown in Table V below.

TABLE V

| Example 4 | Monomer (96 wt %) | IOC8 SbF6 | TPED |
|---|---|---|---|
| 4A | EPON 862 (100 wt | 2 wt % | 2 wt % |
| | %) | | |
| 4B | EPON 862 + | 2 wt % | 2 wt % |
| | Resorcinol | | |
| | diglycidyl ether (90 | | |
| | wt % + 10 wt %) | | |
| 4C | EPON 862 + | 2 wt % | 2 wt % |
| | Resorcinol | | |
| | diglycidyl ether (70 | | |
| | wt % + 30 wt %) | | |
| 4D | EPON 862 + | 2 wt % | 2 wt % |
| | Resorcinol | | |
| | diglycidyl ether (50 | | |
| | wt % + 50 wt %) | | |

Viscosities of the resulting frontal resins fromed in 4A-4D ranges from 3.4 Pa·S to 7.3 Pa·S. Frontal polymerization was successful under the buried interfaces forming transparent cured adhesive with negligible defects in comparison to standard resin mentioned in Example 1. Additionally, during lap shear testing substrate failure was observed for the frontal resin formulations mentioned in this example.

### Example 5

In this Example, 2 wt. % of homopolymer polymethyl methacrylate (PMMA with Mw of 350 k) or 2 wt. % of block copolymer styrene-butadiene-styrene (SBM) were added to the diglycidyl ether of Bisphenol F (EPON 862). The reaction mixture is prepared following the materials and method of Example 1 where the monomer EPON 862 is present in an amount of 94 wt %. The initiator IOC8 SbF6 was used in an amount of 1.96 wt % and TPED (co-initiator) was used in an amount of 1.96 wt %. The mixture was heated at 90° C. for 2-3 hours to achieve homogenized resin and allowed to mix for 2 hrs at 60 ° C. The prepared resin formulation has high viscosity (as tabulated below), higher than commercial two part epoxy resin. Additionally, lap shear adhesion testing was performed between two polycarbonate substrates using the resin with 2 wt. % PMMA and with 2 wt. % SBM. Frontal polymerization was successful under the buried interfaces and substrate failure was observed, indicating that the additive did not negatively impact the adhesive strength. The results are shown in Table VI.

TABLE VI

| Resin | Zero Shear Viscosity (Pa · s) |
|---|---|
| Standard | 1.70 |
| EPON 862 + Initiators | 9 |
| EPON 862 + 2 wt. % PMMA + Initiators | 1062 |
| EPON 862 + 2 wt. % SBM + Initiators | 39.8 |

Applications of the above composition may include adhesives, coatings, the creation of gradient materials, and composites.

It is to be noted that all ranges detailed herein include the endpoints. Numerical values from different ranges are combinable.

The term “and/or” includes both “and” as well as “or.” For example, “A and/or B” is interpreted to include A, B, or A and B.

While the invention has been described with reference to some embodiments, it will be understood by those skilled in the art that various changes may be made, and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

1. A composition comprising:
a first epoxide comprising a first glycidyl epoxide and/or a first non-glycidyl epoxide;
a second epoxide comprising a second glycidyl epoxide and/or a second non-glycidyl epoxide;
wherein the first glycidyl epoxide is different from the second glycidyl epoxide and wherein the first non-glycidyl epoxide is different from the second non-glycidyl epoxide;
wherein the first and the second epoxide are cationically polymerizable;
an initiator; and
a filler, where the composition upon external stimulus undergoes an ionic polymerization reaction in a spatially propagating reaction front or in a global reaction that occurs throughout an entire composition, and wherein the viscosity is about 1 to 25,000 Pa·s as measured with a rheometer using a parallel plate fixture.

2. The composition of claim 1, wherein the first glycidyl epoxide and the second glycidyl epoxide comprises glycidyl ethers based on phenols.

3. The composition of claim 2, wherein the phenol is resorcinol, bisphenol A, bisphenol F or mixtures thereof.

4. The composition of claim 1, where the first glycidyl epoxide and/or the second glycidyl epoxide glycidyl epoxide are present in a combined amount of 1 wt % to 50 wt %, based on the total weight of the composition.

5. The composition of claim 1, where the first non-glycidyl epoxide and the second non-glycidyl epoxide is bis(2,3-epoxycyclopentyl) ether, 1,2-bis(2,3-epoxycyclopentyloxy)ethane, 3,4-epoxycyclohexyl-methyl 3,4-epoxycyclohexanecarboxylate, 3,4-epoxy-6-methyl-cyclohexylmethyl 3,4-epoxy-6-methylcyclohexanecarboxylate, di(3,4-epoxycyclohexylmethyl)hexanedioate, di(3,4-epoxy-6-methylcyclohexylmethyl) hexanedioate, ethylenebis(3,4-epoxycyclohexanecarboxylate, ethanediol di(3,4-epoxycyclohexylmethyl)ether, vinylcyclohexene dioxide, dicyclopentadiene diepoxide or 2-(3,4-epoxycyclohexyl-5,5-spiro-3,4-epoxy)cyclohexane-1,3-dioxane, or 2,2′-bis-(3,4-epoxy-cyclohexyl)-propane.

6. The composition of claim 1, where the first non-glycidyl epoxide and/or the second non-glycidyl epoxide is present in a combined amount of 40 wt % to 70 wt %, based on the total weight of the composition.

7. The composition of claim 1, where the first non-glycidyl epoxide or the second non-glycidyl epoxide non-glycidyl epoxide is 3,4-epoxycyclohexylmethyl-3′,4′-epoxycyclohexane carboxyl ate.

8. The composition of claim 1, where the initiator comprises a free radical initiator and an ionic initiator.

9. The composition of claim 1, wherein the initiator is present in an amount of wt % to 2.5 wt %, based on the total weight of the composition.

10. The composition of claim 1, where the filler is silica, alumina, calcium carbonate or a polymer.

11. The composition of claim 1, where the polymer is a homopolymer or a block copolymer.

12. The composition of claim 1, wherein the amount of filler is up to 30 wt %, based on the total weight of the composition.

13. An article comprising the composition of claim 1.

14. The article of claim 13, where the average shear strength of the composition when bonded to a substrate is about 0.5 MPa to 10 MPa.

15. The article of claim 14, where the substrate is polyolefin, polycarbonate, glass, metal, or wood.

16. A method of manufacturing a composition comprising:
mixing together a mixture prepared by a composition comprising:
a first epoxide comprising a first glycidyl epoxide and/or a first non-glycidyl epoxide;
a second epoxide comprising a second glycidyl epoxide and/or a second non-glycidyl epoxide;
wherein the first glycidyl epoxide is different from the second glycidyl epoxide and wherein the first non-glycidyl epoxide is different from the second non-glycidyl epoxide;
an initiator; and
a filler.

17. The method of claim 16, further comprising subjecting the mixture to an external stimulus; wherein the stimulus facilitates polymerization of the mixture.

18. The method of claim 16, where the temperature attained by the polymerized mixture is about 200° C. to 300° C.

19. The method of claim 17, where the external stimulus comprises heat or UV radiation.
